(19) United States
(12) Patent Application Publication
(10) Pub. No.: US 2025/0371523 A1
(43) Pub. Date: Dec. 4, 2025

(54) CREDENTIAL PRESENTATION INITIATED BY AN UNSUPPORTED PLATFORM

(71) Applicant: Apple Inc., Cupertino, CA (US)

(72) Inventors: David R. STOCKLEY, London (GB); Eric K. KIMN, Cupertino, CA (US); Jeffrey SIMON, San Jose, CA (US); Kanishk MERSETI, San Jose, CA (US); Mark R. DANKS, London (GB); Sunil NAIR, Fremont, CA (US); Nicholas J. SHEARER, London (GB)

(21) Appl. No.: 18/793,662

(22) Filed: Aug. 2, 2024

Related U.S. Application Data
(60) Provisional application No. 63/654,886, filed on May 31, 2024.

(51) Int. Cl. G06Q 20/36; G06Q 20/40

(52) U.S. Cl. CPC G06Q 20/363; G06Q 20/40

(57) ABSTRACT

The subject system may be implemented by a processor circuit configured to establish, by a digital wallet launched on the first user device, a communication channel with a first server associated with a payment provider, the payment provider being used in a transaction between a merchant website accessed on a second user device and a second server associated with the merchant website, wherein the second user device does not support the payment provider, receive, by the digital wallet and from the first server, transaction information corresponding to the transaction, provide, by the digital wallet and to the first server, a payment credential stored on the first user device, and receive, by the digital wallet and from the first server, a result of the transaction performed using the payment credential on behalf of the first user device.

### CROSS-REFERENCE TO RELATED APPLICATIONS

The present application claims the benefit of U.S. Provisional Patent Application Ser. No. 63/654,886, entitled “CREDENTIAL PRESENTATION INITIATED BY AN UNSUPPORTED PLATFORM,” filed May 31, 2024, which is hereby incorporated herein by reference in its entirety.

### TECHNICAL FIELD

The present description generally relates to digital credentials on electronic devices and, more particularly, to allowing a digital credential on a first electronic device to be presented for a transaction being conducted by a second electronic device.

### BACKGROUND

A digital credential is an electronic version of a physical credential, often used for identification, access, or payment purposes. The digital credential may be stored on a digital wallet of a smartphone, computer, or other electronic device and used in place of physical credentials, such as ID cards, credit cards, or membership cards. The type of information and/or access provided by a digital credential may include simple identification and authentication to more complex entitlements and payments, such as credit card payments or other services. Information corresponding to a digital credential may be represented by an identifier, such as a token, device number, and/or the like, which may be presented for use, for example, as an image, sound, code, signal, and/or the like.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment for presenting a digital credential, in accordance with one or more implementations.

FIG. 2 depicts an example electronic device that may implement the subject methods and systems, in accordance with one or more implementations.

FIG. 3 depicts a user interface on a laptop for making a payment, in accordance with one or more implementations.

FIG. 4 depicts a user interface on a laptop for initiating credential presentation, in accordance with one or more implementations.

FIG. 5 depicts a user interface on a smartphone for presenting a credential, in accordance with one or more implementations.

FIG. 6 depicts a sequence diagram of an example process for presenting a credential, in accordance with one or more implementations.

FIG. 7 depicts a flow diagram of an example process for presenting a credential from another electronic device, in accordance with or more implementations.

FIG. 8 depicts a flow diagram of an example process for presenting a credential to another electronic device, in accordance with or more implementations.

FIG. 9 depicts an example electronic system with which aspects of the present disclosure may be implemented, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A digital credential may be a form of electronic verification used to authenticate and/or verify the identity and/or an account of the holder through digital means, enabling secure access to payments, services, resources, and/or information. A digital credential can encompass a wide array of digital entities, including but not limited to digital payment cards, which can be integrated into digital wallets of smartphones for NFC-based payments. Digital credentials may be encoded with information that identifies and confirms the legitimacy of the holder and/or account, utilizing cryptographic methods for data integrity and security. Unlike traditional physical credentials, digital credentials may offer a more convenient, secure, and efficient means of carrying and presenting proof of payment, identity, eligibility, or authority, facilitating seamless transactions and interactions in various domains, from financial transactions to secure access to online services.

Although digital credentials may be stored on a particular platform (e.g., device, operating system, application, etc.), a user may not be able to present or otherwise use the digital credential on another platform unless the two platforms are specifically developed to perform such coordination. The lack of interoperability across different platforms poses a challenge in the utilization of digital credentials and may arise due to the proprietary nature of many digital credential systems, where credentials stored on one platform (e.g., manufactured or maintained by a first entity) cannot be readily accessed or used on a different platform (e.g., manufactured or maintained by a second entity). This incompatibility may be due to divergent security protocols, data formats, and communication standards across platforms, which prevent the sharing or validation of credentials between them.

Aspects of the subject technology provide mechanisms for allowing digital payments on the web to be initiated on a user's second entity platform and completed with a digital credential provided by the user's first entity platform (and/or a digital credential provided by a first entity platform of another user associated with the user, such as in a family sharing arrangement). The first entity and second entity may be separate entities that each manufacture or maintain platforms that may not be natively compatible with particular features of the other entity's platforms. In some examples, the digital payment may be initiated on a web browser (e.g., platform) associated with a second entity and the payment credential may be provided by a digital wallet (e.g., platform) associated with the first entity, and the web browser and digital wallet may be on the same device or separate devices (the separate devices may be manufactured or maintained by the same or separate entities). In some examples, the digital payment may be initiated on a device (e.g., platform) associated with a second entity and the payment credential may be provided by a digital wallet associated with the first entity and running on a separate device (e.g., platform). Other combinations of platforms and their corresponding entities are contemplated.

A merchant website may include a digital credential software (e.g., JavaScript) library (also referred to herein as a script) for a particular payment provider. If the software library determines that a browser rendering the merchant website is a browser (e.g., a platform manufactured or maintained by a second entity) that does not natively support payments via the particular payment provider (e.g., developed or maintained by a first entity), the browser may display a UI (e.g., hosted by the first entity) prompting the user to connect their first entity platform to complete an interaction (e.g., payment). The first entity platform may initialize a connection between the merchant website and a payment provider server (e.g., operated by the first entity) by accessing a temporary code (e.g., scanning a quick-response (QR) code) or logging in to an account associated with the payment provider server and/or the first entity. The first entity platform may maintain the connection for the duration of the interaction and receive the merchant's credential request over the connection. When the credential request is received, the first entity platform may present a locally stored credential (e.g., in a secure element of the first entity device) to the merchant website via the payment provider server over the connection. It should be understood that, although some implementations are discussed herein with respect to financial transactions, the subject technology is not limited to financial transactions and may be used to present, on the second entity platform and via the payment provider server, any information stored on the first entity platform, such as a digital identity credential, a digital loyalty credential, or any other digital information.

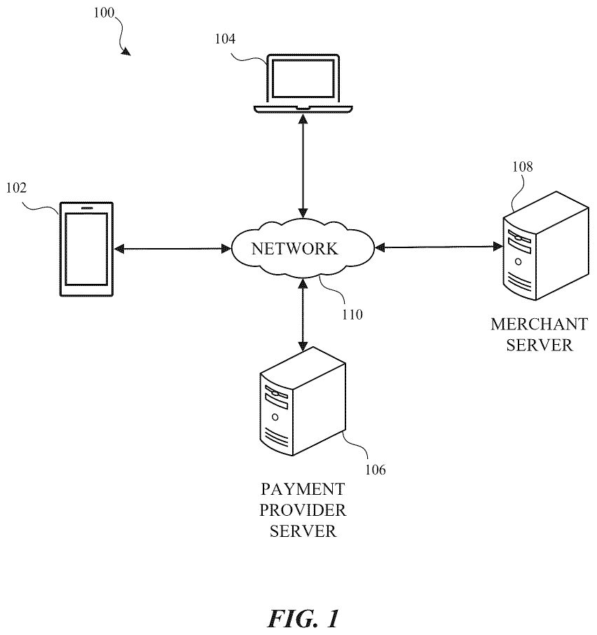

FIG. 1 illustrates an example network environment 100 for presenting a digital credential, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, one or more other electronic devices (e.g., electronic device 104), and one or more servers (e.g., merchant server 108 and payment provider server 106). The network 110 may communicatively (directly or indirectly) couple the electronic device 102, electronic device 104, the merchant server 108, and/or the payment provider server 106. In one or more implementations, the network 110 may be an interconnected network of devices that may include, or may be communicatively coupled to, the internet. For explanatory purposes, the network environment 100 is illustrated in FIG. 1 as including the electronic device 102, electronic device 104, payment provider server 106, the merchant server 108, and the payment provider server 106; however, the network environment 100 may include any number of electronic devices and/or any number of servers communicatively coupled to each other directly or via the network 110. Aspects of the subject technology may allow communication of digital credentials associated with an electronic device (e.g., electronic device 102) to other electronic devices (e.g., electronic device 104), as is discussed further below.

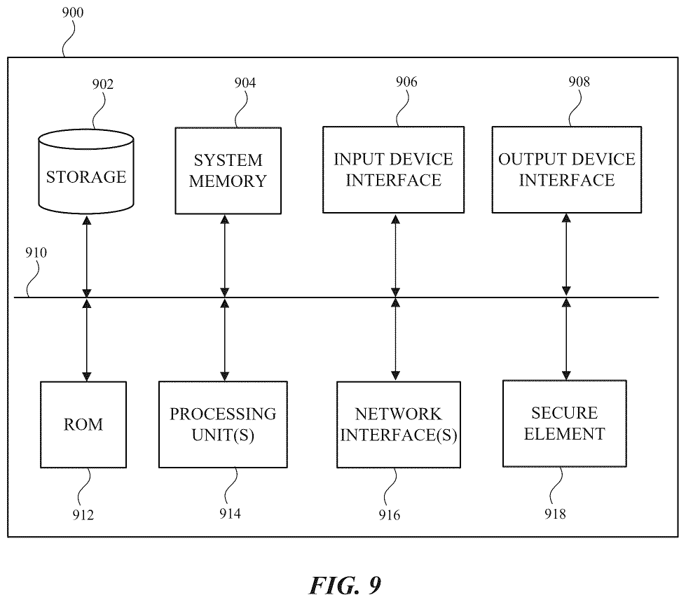

The electronic device 102 may be, for example, a wearable device such as a watch, a band, and the like, a desktop computer, a portable computing device such as a laptop computer, a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a smartphone. The electronic device 102 may be, and/or may include all or part of, the electronic system discussed below with respect to FIG. 9. The electronic device 102 may include one or more digital wallet applications and one or more digital credentials. The electronic device 102 may be manufactured by and/or utilize software (e.g., operating system, digital wallet application, etc.) of a first entity, also referred to herein as a “first entity platform” or “first entity device.” The electronic device 102 may also be associated with a user account. For example, the electronic device 102 may be registered to a user account with a payment provider.

The electronic device 104 may each be a similar electronic device as described with respect to the electronic device 102. In FIG. 1, by way of example, the electronic device 104 is depicted as a laptop. The electronic device 104 may be, and/or may include all or part of, the electronic system discussed below with respect to FIG. 9. The electronic device 104 may be manufactured by and/or utilize software (e.g., operating system, web browser application, etc.) of a second entity, which may be different than the first entity, also referred to herein as a “second entity platform” or “second entity device.” For example, in some instances, the electronic device 102 and the electronic device 104 may be manufactured by the same entity and/or run an operating system developed by the same entity but the electronic device 104 may be running a web browser (e.g., to perform at least some of the aspects of the subject technology) developed or maintained by a different entity, and thus the electronic device 104 running the web browser to perform at least some aspects of the subject technology is referred to herein as a second entity device.

The merchant server 108 may be manufactured or maintained by a third entity and may facilitate interactions between the electronic device 104 and various online services or resources. Operating within a networked environment (e.g., network 110), the merchant server 108 may host and deliver content, such as web pages, media files, and application data, to devices (e.g., electronic device 104) via the network 110 (e.g., internet or intranet). For example, when a user initiates a request from the electronic device 104—be it for accessing a website, submitting form data, or initiating a transaction—the request may be sent over the network 110 to the merchant server 108. The merchant server 108 may process the request, executing backend logic which may involve querying databases, processing transactions, or interacting with other services. Upon completion, the merchant server 108 may generate a response, which could be a web page, a confirmation message, or the requested data, and may send it back to the electronic device 104 for display or further processing by a client-side application (e.g., a web browser). Interactions facilitated by the merchant server 108 may be governed by standardized protocols, such as HTTP/HTTPS, and may be designed to handle concurrent requests from multiple users, employing technologies like caching, load balancing, and SSL/TLS encryption to optimize performance, manage network traffic, and safeguard sensitive information.

The payment provider server 106 may facilitate interoperability and/or communication between, for example, the electronic device 102 and the electronic device 104 as an intermediary, such as when conducting a payment transaction. For example, the payment provider server 106 may be a server of a digital wallet provider and/or a server of a payment provider. The payment provider server 106 may receive requests or data from the electronic device 102, and then process, converts, re-package, translate, validate, and/or forward these requests to the electronic device 104 in a format compatible with the electronic device 104 and/or the merchant server 108. Additionally, the payment provider server 106 can provide services such as data encryption and decryption to maintain the security and privacy of the transmitted information and/or perform authentication and authorization functions, verifying the identities of devices and users to prevent unauthorized access. In some examples, the payment provider server 106 may be under the development and/or control of the first entity, thereby enabling tighter integration with the electronic device 102, the electronic device 104, and/or platforms running thereon.

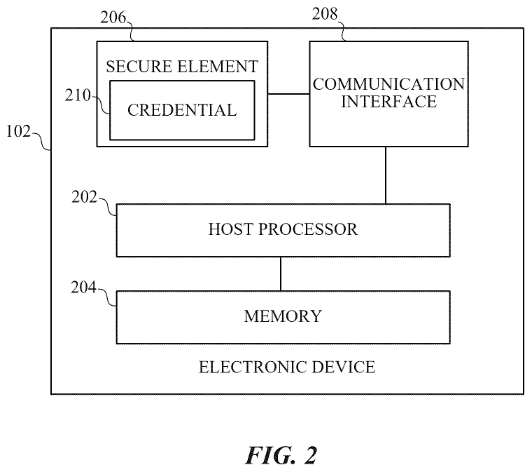

FIG. 2 depicts an example electronic device 102 that may implement the subject methods and systems, in accordance with one or more implementations. For explanatory purposes, FIG. 2 is primarily described herein with reference to the electronic device 102 of FIG. 1. However, this is merely illustrative, and features of the electronic device of FIG. 2 may be implemented in any other electronic device for implementing the subject technology. Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a host processor 202, a memory 204, a secure element 206, and/or a communication interface 208. The host processor 202 may include suitable logic, circuitry, and/or code that enable processing data and/or controlling operations of the electronic device 102. In this regard, the host processor 202 may be enabled to provide control signals to various other components of the electronic device 102. The host processor 202 may also control transfers of data between various portions of the electronic device 102. The host processor 202 may further implement an operating system or may otherwise execute code to manage operations of the electronic device 102.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). In one or more implementations, the memory 204 may store applications and application data (e.g., digital credentials).

The secure element 206 may include hardware that provides secure storage and management of sensitive information. The secure element 206 may be securely isolated from the host processor 202 and operating system, making it more difficult for unauthorized access. The secure element 206 may be used for secure transactions and/or identification, such as in payment credentials, digital passes, and the like. The secure element 206 may store sensitive information, such as cryptographic keys or digital credentials 210, and may protect the sensitive information with cryptographic algorithms and access controls. For example, the secure element 206 may include a hardware specific private key that is provisioned on the secure element 206 at or near the time of manufacture. The use of the secure element 206 provides an additional layer of security for sensitive information and helps to ensure its confidentiality in case the electronic device 102 is lost or compromised.

The communication interface 208 may include suitable logic, circuitry, and/or code that enables wired or wireless communication, such as between the electronic device 102 and the merchant server 108. The communication interface 208 may include, for example, one or more of a Bluetooth communication interface, an NFC interface, a Zigbee communication interface, a WLAN communication interface, a USB communication interface, a cellular interface, or generally any communication interface.

In one or more implementations, one or more of the host processor 202, the memory 204, the secure element 206, the communication interface 208, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

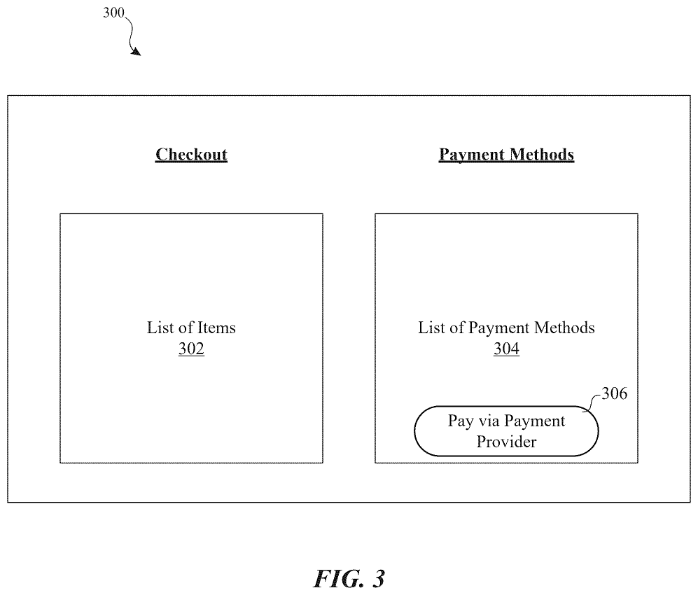

FIG. 3 depicts a user interface 300 on the electronic device 104 for making a payment, in accordance with one or more implementations. The electronic device 104 may render the user interface 300 on a web browser distributed or developed by a second entity. The user interface 300 rendered on the web browser may be associated with a script, library, or other codebase that runs on the web browser alongside the user interface 300 and is developed and/or distributed by a first entity, such as the payment provider server 106.

As shown in FIG. 3, the user interface 300 is a checkout page for purchasing a list of items 302. As part of the user interface 300, the web browser may also render a list of payment methods 304 for completing the purchase of the list of items 302. The list of payment methods 304 may be built or coded into the web page associated with the user interface 300 and/or may be dynamically inserted into the web page by the script. The script may recognize (e.g., upon rendering the user interface 300) that the web browser is associated with the second entity, and therefore does not natively support payments via the web browser, and then may render the interface element 306 to pay via the payment provider with a first entity platform (e.g., electronic device 102).

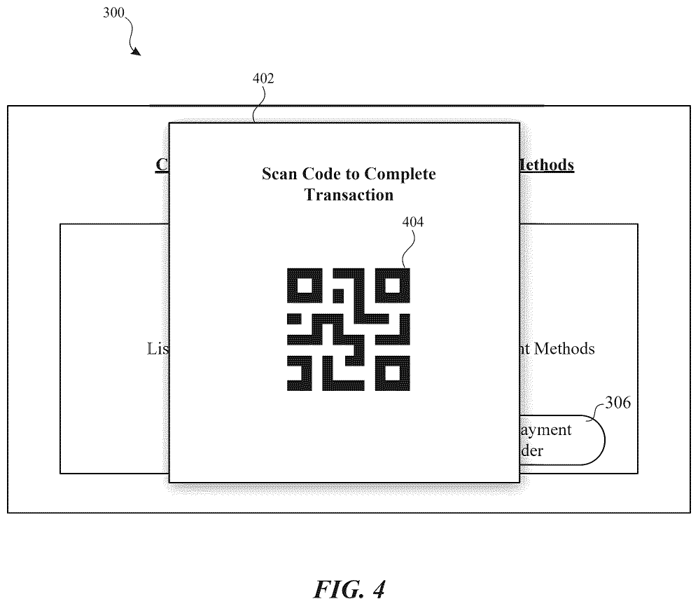

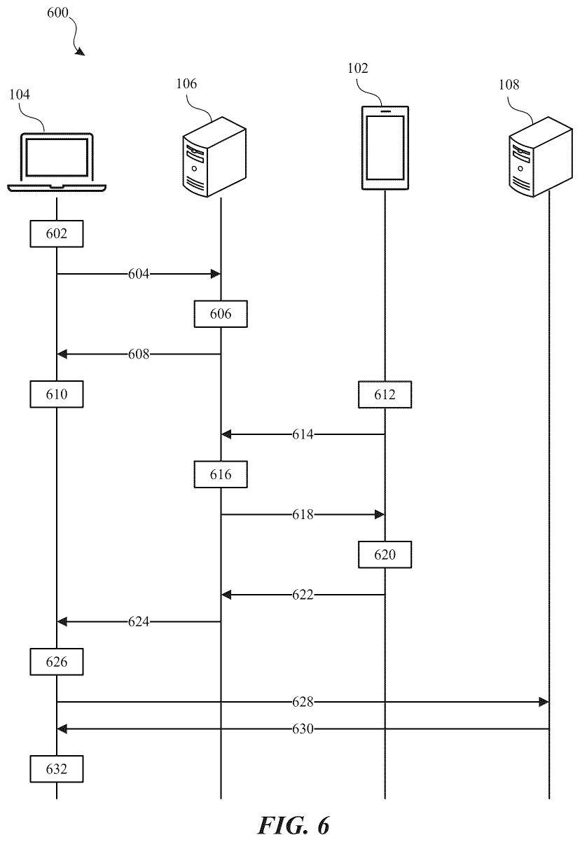

FIG. 4 depicts the user interface 300 on the electronic device 104 for initiating credential presentation, in accordance with one or more implementations. If the interface element 306 is selected and/or activated, one or more processes, such as those described with respect to FIGS. 6-8, may be executed. It is contemplated that pressing an interface element 306 to initiate the processes herein is merely an example and not intended to be limiting. In some examples, the interface element 306 may be any other kind of interactive element, such as a voice command. In some examples, the processes may be initiated automatically, e.g., in response to a user preference. If the interface element 306 is pressed, the user interface 300 and/or the web browser may present or otherwise provide (e.g., on a popup 402) a code 404, such as a QR code, barcode, or other visible code. The code 404 may be scanned by electronic device 102 and/or any other device that includes an image sensor and encodes information (e.g., tokens, URLs, access codes, and/or the like) that may allow the electronic device 102 to connect to the payment provider server 106, to which the electronic device 104 may already be connected or may become connected (e.g., by the script).

In some examples, the electronic device 104 may connect to the payment provider server 106 when the user interface 300 is rendered (e.g., due to the script on the web page).

In some examples, the electronic device 104 may connect to the payment provider server 106 when the interface element 306 is pressed.

In some examples, the electronic device 104 may connect to the payment provider server 106 responsive to scanning and decoding the code 404 and/or the electronic device 102 is connected to the payment provider server 106. When the electronic device 102 and the electronic device 104 are connected to the payment provider server 106, information may be sent to and/or received from either electronic device 102, 104 via the payment provider server 106.

In some examples, the code 404 be an alphanumeric code that the user may input into the electronic device 102 to connect the electronic device 102 to the payment provider server 106.

In some examples, the code 404 may be rotatable. That is, the code 404 may have a lifespan (e.g., of a few seconds, such as 10 seconds). For the amount of time the electronic device 104 and electronic device 102 may have a connection with the payment provider server (e.g., 5 minutes), the code 404 may be regenerated and/or refreshed each time it expires (e.g., every 10 seconds).

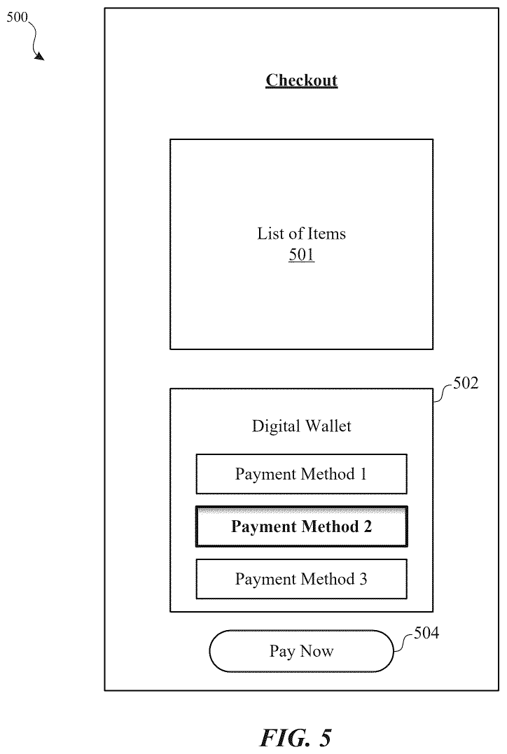

FIG. 5 depicts a user interface 500 on the electronic device 102 for selecting a digital credential (e.g., credential 210) for presentation in a transaction, in accordance with one or more implementations. The electronic device 102 may render the user interface 500 that corresponds to an application, such as a digital wallet, that is executed on the electronic device 102. The user interface 500 may be rendered in response to establishing a connection with the payment provider server 106 and receiving information from the payment provider server 106 about a transaction initiated on the electronic device 104, described in FIG. 4 and FIG. 5. With the information from the payment provider server 106, the user interface 500 may be rendered to include the list of items 501 (which may correspond to the list of items 302) for checkout. The user interface 500 may also include a list of payment methods 502 stored on the electronic device 102, such as payment credentials (e.g., credential 210) stored on the digital wallet (e.g., utilizing the secure element 206) of the electronic device 102. In one or more implementations, the user interface 500 may display less or more information regarding the transaction. For example, the user interface 500 may display the total price without displaying the list of items 501.

In some implementations, the user interface 500 may also include additional details about the transaction, such as a billing address, delivery address, and/or any other information relating to the transaction. The user interface 500 may be used to receive one or more user inputs to modify the transaction. For example, the user may remove an item from the list of items 501 displayed on the user interface 500. When the transaction is modified via the user interface 500, the electronic device 102 may communicate the changes to the electronic device 104 via the payment provider server 106, and the electronic device 104 can modify the transaction (e.g., with the merchant server 108). For example, the electronic device 102 may transmit the changes to the payment provider server 106, which may subsequently transmit the changes to the electronic device 104 for the electronic device 104 to modify the transaction by communicating with the merchant server 108. The modified transaction data can be communicated back to the electronic device 102 from the electronic device 104 via the payment provider server 106, and the user interface 500 may be updated accordingly. This way, the state of the transaction can be synchronized across the electronic device 102, the electronic device 104, and/or the merchant server 108 despite the limited compatibility between the electronic device 102 and the electronic device 104.

When the user selects a payment method from the list of payment methods 502, the user may approve the transaction, for example, by selecting an interface element 504. When the transaction is approved, the electronic device 102 may perform authentication to verify the identity of the approver (e.g., via biometric scan), authorization to verify that the transaction can be completed, and/or direct its secure element to send payment information to the merchant server 108. For example, the electronic device 102 may send payment information to the merchant server 108 by sending the payment information to the payment provider server 106, which may then provide the payment information to the electronic device 104, which may then provide the payment information to the merchant server 108. In some embodiments, the electronic device may send payment information to the merchant server 108 by sending the payment information to the payment provider server 106, which may then provide the payment information directly to the merchant server 108. The payment information may include the payment credential associated with the selected payment method (e.g., from the secure element 206). The payment information may also or instead include a payment object containing an encrypted payment token (decryptable by the merchant server 108 and/or a payment provider server 106), and the token may encapsulate the information used to complete a transaction, such as a device-specific account number of the electronic device 102 (associated with the payment credential), the amount of the transaction, and/or a single-use cryptogram. The payment information may be sent to the electronic device 104 via the payment provider server 106, and the electronic device 104 may send the payment information to the merchant server 108 to complete the transaction. In some implementations, the payment provider server 106 may send the payment information directly to the merchant server 108 to complete the transaction. When the transaction is completed, the merchant server 108 may return a confirmation to the electronic device 102 (e.g., via the electronic device 104 and/or the payment provider server 106).

FIG. 6 depicts a sequence diagram 600 of an example process for presenting a digital credential, in accordance with one or more implementations. For explanatory purposes, the sequence diagram 600 is primarily described herein with reference to the electronic device 102, the electronic device 104, the payment provider server 106, and the merchant server 108 of FIG. 1. However, the sequence diagram 600 is not limited to the electronic device 102, the electronic device 104, the payment provider server 106, or the merchant server 108, and one or more boxes of the sequence diagram 600 may be performed by one or more other components of the merchant server 108, and/or by other suitable devices. Further, for explanatory purposes, the boxes of the sequence diagram 600 are described herein as occurring sequentially or linearly. However, multiple boxes of the sequence diagram 600 may occur in parallel. In addition, the boxes of the sequence diagram 600 need not be performed in the order shown and/or one or more boxes of the sequence diagram 600 need not be performed and/or can be replaced by other operations.

At box 602, a user may initiate a transaction on the electronic device 104. As an example, the user may use a web browser installed on the electronic device 104 to browse the website of a merchant (e.g., hosted by merchant server 108) and/or may use an application (“app”) of the merchant. The user may select one or more items for purchase and proceed to a checkout page (e.g., user interface 300).

While browsing the website (e.g., upon accessing the checkout page), the script may be delivered to the electronic device 104 as part of the page content. This may be handled by, e.g., embedding the script within the HTML content of the page and/or by including the script as an external file that is fetched when the page loads. The execution of the script may be triggered, e.g., once the page has fully loaded so that the page elements are in place for any interactions by the script. Alternatively, the script may be activated when the user selects a payment option, making the check immediate and relevant to the user's choice.

When executed, the script may cause the browser and/or app to determine whether the browser and/or the electronic device 104 supports a particular payment provider. Determining whether the payment provider is supported may include querying an API that facilitates the integration of the payment provider into web applications. For example, the script may query browser-supported APIs such as a Payment Request API, which provides a way for integrating payment providers into web applications. The script may use conditional checks to determine if the API exists and whether it supports the particular payment provider. If the API is available, a payment request may be initiated. The API's response to the request may indicate whether the particular payment provider is available. This may involve checking the registration of the payment provider of the electronic device 104, availability of prerequisite hardware (e.g., NFC for contactless payments), and/or software components (e.g., digital wallets).

If the script determines that the particular payment provider is supported, the script may cause the browser to render an interface element to pay with the particular payment provider. Otherwise, the script may cause the browser to proceed to box 604.

At box 604, the browser has determined that it may not support the particular payment provider but may offer the user an option to pay with the particular payment provider via the electronic device 102. Because the script, the electronic device 102, and the particular payment provider may be associated with a first entity (e.g., the same developer, manufacturer, or any other mutual affiliation)—whereas the user's browser and/or electronic device 104 may be associated with a second entity—the script can cause the second entity browser and/or electronic device 104 to interoperate with the electronic device 102 via the payment provider server 106, which may operate and/or be associated with the particular payment provider.

If the user decides to proceed with the particular payment provider (e.g., by interacting with the interface element 306), the script may cause the browser to establish a connection with the payment provider server 106. Establishing a payment session may involve creating a secure communication channel between the electronic device 104 and the payment provider server 106.

In scenarios where real-time, bidirectional communication is used-such as for immediate transaction updates or maintaining a continuous interaction during the payment process-WebSockets may be employed, for example. WebSockets provide a full-duplex communication channel over a single, persistent connection, which may allow messages to be passed back and forth between the client and server without the overhead of repeated HTTP connections. To use WebSockets for establishing a payment session, the script may initiate a WebSocket connection by sending a request to the WebSocket URL provided by, e.g., the payment provider server 106. The URL may be secured (wss://), so that the data exchanged over this connection is encrypted. Upon establishing this WebSocket connection, the electronic device 104 can send and receive payment details, such as transaction data, to the payment provider server 106 in a secure manner.

At box 606, the payment provider server 106 may prepare a session for facilitating communications between the electronic device 104 and another device, such as the electronic device 102. Preparations may include performing validations (e.g., of the browser and/or the merchant).

At box 608, the payment provider server 106 may generate and return a session ID to the electronic device 104. The session ID may be used by other devices, such as the electronic device 102, to establish a connection with the payment provider server 106 and provide one or more payment credentials to the electronic device 104 via the payment provider server 106. The session ID may be unique to the particular transaction that the electronic device 104 is engaged in with the merchant. The session ID may also or instead be unique to an account of the user (e.g., the account associated with the payment provider).

At box 610, the electronic device 104 facilitates handing off the session to another device associated with the user. In one approach, the script may generate and/or present a scannable code (e.g., code 404) on the electronic device 104 that represents information to facilitate the electronic device 102 with connecting to the payment provider server 106. The scannable code may represent information such as a session ID, a URL or other address associated with the payment provider server 106, transaction details (e.g., payment amount and currency), a timestamp, encryption keys (e.g., public key), and/or any other information related to the transaction and/or a connection with the payment provider server 106. The scannable code may be a QR code that may be scanned (e.g., by the user with the electronic device 102). Scanning the scannable code (e.g., with a camera of the electronic device 102) may supply the electronic device 102 with the information to connect to the payment provider server 106 so that the payment provider server 106 may relay information between the electronic device 104 and the electronic device 102.

In some implementations, the scannable code may be generated by the payment provider server 106 at box 606 and sent to the electronic device 104 at box 608.

In some implementations, the scannable code may also or instead be a bar code, an NFC code, an alphanumeric code, and/or the like that may be captured by one or more sensors of the electronic device 102.

In another approach, the script may render a login screen for the user to login to an account associated with the electronic device 102, the payment provider server 106, and/or the payment provider. Once logged in, the script may generate, or cause to be generated, a push notification to the devices associated with the logged in account, such as the electronic device 102, or to devices presented by the script and selected by the user.

In some implementations, the scannable code may be a machine-readable code, such as a URL, URI, barcode, and/or the like. The scannable code may also or instead be a human-readable code, such as an alphanumeric code, PIN, confirmation number, and/or the like.

At box 612, the electronic device 102 may scan the scannable code (e.g., with its camera) to obtain information that the electronic device 102 may use to connect to the payment provider server 106 server.

At box 614, upon scanning the scannable code, the electronic device 102 may extract or otherwise decode the information represented by the scannable code and use the information to establish its own connection to the payment provider server 106. The electronic device 102 may initiate communication with the payment provider server 106 by sending a request that may include the information from the scannable code and/or other authentication information. The request may also include additional metadata such as the device type, operating system information, location data, and/or the like. The connection between the electronic device 102 and the payment provider server 106 may be of the same type as the connection between the electronic device 104 and the payment provider server 106. For example, both connections may be WebSocket connections.

At box 616, the payment provider server 106, upon receiving the request from the electronic device 102, may validate the session identifier to determine that it corresponds to an active and valid session. This validation process might involve checking the session identifier against a database of active sessions, verifying cryptographic signatures of the session identifier to determine that it has not been tampered with, and/or confirming that the session identifier has not expired based on a timestamp.

After validating the request, the payment provider server 106 may proceed to associate the electronic device 102 with the existing session. The payment provider server 106 may then facilitate a communication channel between the electronic device 102 and the electronic device 104. This channel may enable the electronic device 102 to act as an input and/or output device for the electronic device 104, allowing the user to interact with the script through their electronic device 102. This interaction might be further enhanced by WebSocket or similar technologies that support real-time, bidirectional communication between the electronic device 102, electronic device 104, and/or payment provider server 106.

At box 618, the payment provider server 106 may then send a confirmation back to the electronic device 102, which could include a success message, session-specific parameters, or further cryptographic keys for encrypted communication within the session. In some implementations, the payment provider server 106 may push the current state of the session to the electronic device 102, allowing it to synchronize with ongoing activities and/or data displayed on the electronic device 104 and be ready to participate in the interaction facilitated by the payment provider server 106. The communication between the electronic device 102, the payment provider server 106, and/or the electronic device 104 may continue over a secure, real-time protocol, such as WebSockets, so that all devices involved can communicate efficiently and securely in a synchronized manner.

At box 620, following the establishment of the session between the electronic device 102 and the payment provider server 106, the electronic device 102 may proceed to send a payment credential (e.g., credential 210) from a digital wallet (e.g., in memory 204) and/or secure element (e.g., secure element 206) to the electronic device 104 via the payment provider server 106.

At box 622, the electronic device 102 may then send the payment credential to the payment provider server 106 using the secure communication channel previously established. The channel may be protected by encryption protocols like Transport Layer Security (TLS) to safeguard the data in transit, preventing unauthorized access or interception.

At box 624, upon receiving the payment credential, the payment provider server 106 may act as a secure relay. The payment provider server 106 may not store the payment credential but forwards it to the electronic device 104.

At box 626, upon receiving the payment credential from the payment provider server 106, the electronic device 104 may then use the payment credential to process the transaction. The script may generate a payment request, which may include the payment credential along with transaction details, such as the amount to be paid, the currency, and/or other transaction-specific data like customer identification or loyalty program information.

At box 628, the payment request may then be sent to the merchant server 108 or directly to a payment gateway that the merchant uses to handle credit card transactions or other forms of digital payments.

At box 630, upon receipt of the payment request, the payment gateway or the merchant's server may process the transaction. Processing the transaction may involve verifying the payment credential with a bank or credit card issuer, confirming that sufficient funds are available, and/or that the transaction meets certain security criteria. Once the transaction is authorized and processed, the payment gateway or merchant server 108 may send a response back to the script running on the electronic device 104, indicating the success or failure of the transaction.

At box 632, the response from box 630 may be handled by the script to update the user interface accordingly, displaying feedback on the electronic device 104 about the status of the payment-whether it has been successful, declined, or if further action is needed. The script may also or instead provide the feedback to the electronic device 102 via the payment provider server 106, and the electronic device 102 may display feedback about the status of the payment.

After the transaction is completed, the script on the electronic device 104 may then take steps to terminate the session. For example, the script may send a final communication to the payment provider server 106, indicating that the transaction has been completed and that the session can be closed. This message may include transaction results, such as success or failure status, which the payment provider server 106 may then relay to the electronic device 102. The electronic device 102, upon receiving this final status, may update its display to inform the user of the outcome of the payment, providing a clear indication of whether the transaction was successful or if any issues arose.

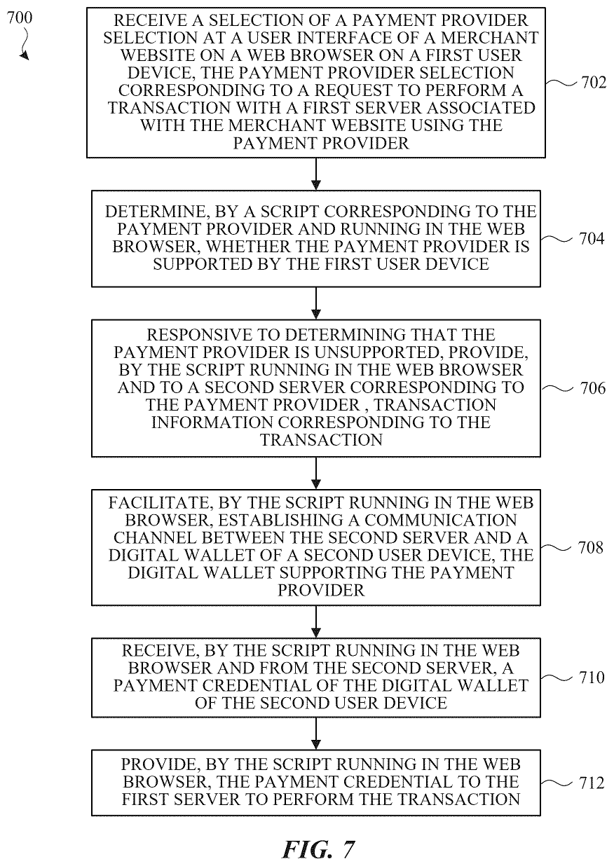

FIG. 7 depicts a flow diagram of an example process 700 for presenting a credential, in accordance with one or more implementations. For explanatory purposes, the process 700 is primarily described herein with reference to the electronic device 102, the electronic device 104, the payment provider server 106, and the merchant server 108 of FIG. 1. However, the process 700 is not limited to the electronic device 102, the electronic device 104, the payment provider server 106, or the merchant server 108, and one or more blocks of the process 700 may be performed by one or more other components of the merchant server 108, and/or by other suitable devices. Further, for explanatory purposes, the blocks of the process 700 are described herein as occurring sequentially or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, the electronic device 104 may receive a selection of a payment provider. The user may select the payment provider from a list of one or more payment providers displayed on a user interface of a merchant website and/or on a user interface of a merchant app. The merchant website may be hosted by a merchant server 108, and the user interface of the merchant website may be rendered on a web browser running on the electronic device 104.

The user interface may be a checkout page (e.g., user interface 300) of the merchant website, and the selection of the payment provider may correspond to a request to perform a transaction between the electronic device 104 and the merchant server 108. The request to perform the transaction may include transaction information such as user information, items to be purchased, payment information, and/or the like. The transaction may be performed when the request is sent to the merchant server for the merchant server to process and facilitate the transaction.

At block 704, a script running on the web browser of the electronic device 104 may verify the selected payment provider for compatibility. The script may be associated with the payment provider and may be embedded in and/or loaded along with the merchant website. For example, the script may be received by the electronic device 104 from a content delivery network associated with the payment provider with a <script> tag in the HTML of the merchant website. The script may include instructions that determine whether the web browser and/or the electronic device 104 supports the payment provider. For example, the script may check one or more attributes of the web browser and/or the electronic device 104 to determine whether the requirements for supporting the payment provider are met. In some implementations, the script may be run on, provided by, or otherwise associated with an extension application of the web browser, where an extension application may be a software module that adds capabilities to a web browser by interacting with the web browser through a set of APIs provided by the web browser.

If the script determines that the payment provider is supported by the web browser and/or the electronic device 104, the rest of the transaction request may be handled on the electronic device 104 (e.g., by the script). Otherwise, the process may proceed to block 706.

At block 706, responsive to determining that the payment provider is unsupported, the script running in the web browser may provide transaction information corresponding to the transaction to a payment provider server 106. In response to the transaction information, the payment provider server 106 may initiate a payment session with the electronic device 104, which may include generating a session identifier.

At block 708, the script running in the web browser may facilitate the establishment of a communication channel between the payment provider server 106 and the electronic device 102. The electronic device 102 may include a digital wallet application, which supports the payment provider, and one or more digital payment credentials. On the electronic device 102, the communication between the payment provider server 106 and the electronic device 102 may be facilitated by the digital wallet application. For example, the digital wallet application may have access to one or more APIs through which the digital wallet application may send requests to the payment provider server 106.

To facilitate the establishment of the communication channel between the payment provider server 106 and the electronic device 102, the script may display a machine-readable code (e.g., a QR code for the electronic device 102 to scan). The machine-readable code may represent information that (e.g., when decoded by the electronic device 102) can be used by the electronic device 102 to establish the communication channel with the payment provider server 106. Additionally or alternatively, the script may cause a push notification to be sent to the electronic device 102. The script may generate a login view for the user to log in to an account associated with the electronic device 102. The script may generate a request for a push notification, which includes the information used by the electronic device 102 to establish the communication channel with the payment provider server 106. The request may be sent to a push notification server to send a push notification to one or more of the devices associated with the user account, such as the electronic device 102.

When the communication channel between the payment provider server 106 and the electronic device 102 is established, the communication channels between the electronic device 104 with the payment provider server 106 and the payment provider server 106 with the electronic device 102 may be treated by the payment provider server 106 as a single channel between the electronic device 104 and the electronic device 102 with the payment provider server 106 acting as a relay. As such, the communication channel may be end-to-end encrypted between the electronic device 104 and the electronic device 102 so that the payment provider server 106 cannot access the contents of the communications on the communication channel.

At block 710, when the communication channel between the payment provider server 106 and the electronic device 102 is established, the script running in the web browser may receive a payment credential. The user may select a payment credential on a user interface of the digital wallet application running on the electronic device 102. The digital wallet application may, or direct the secure element to, access the payment credential from memory and encrypt or otherwise process the payment credential for transmission. The digital wallet application may, or direct the secure element to, transmit the payment credential to the payment provider server 106, which may then transmit the payment credential to the electronic device 104.

In some implementations, the user may modify one or more aspects of the transaction via the user interface of the digital wallet application. For example, the user interface may display the items being purchased and their respective prices. The user may select one of the items to change the quantity of the items being purchased. In response to the modification, the digital wallet application may transmit the modification to the electronic device 104 via the payment provider server 106 to update the transaction. The electronic device 104 may update the transaction request based on the modifications and provide updated transaction information back to the digital wallet application via the payment provider server 106.

At block 712, the script running in the web browser may provide the payment credential to the merchant server. The payment credential may be included in the request to perform the transaction. After the transaction is performed, the script may receive a result of the transaction from the payment server indicating whether the transaction was successful. The script may also forward the result of the transaction to the electronic device 102 via the payment provider server 106.

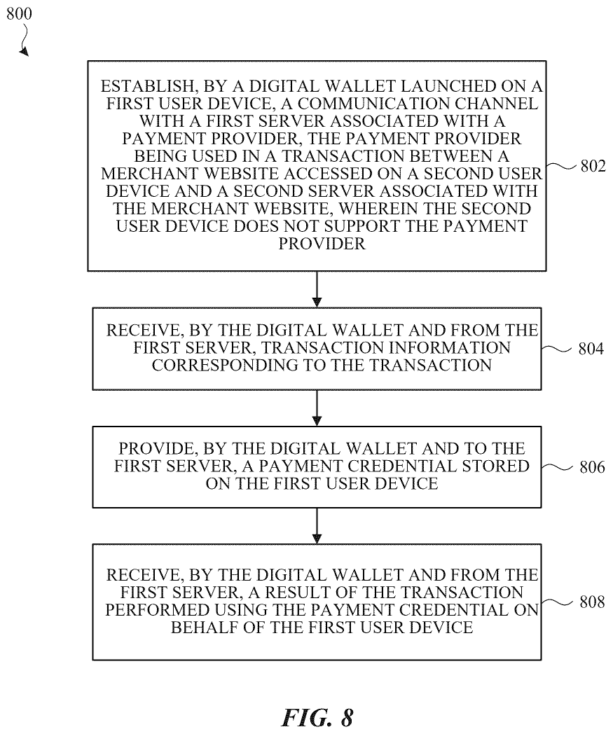

FIG. 8 depicts a flow diagram of an example process 800 for presenting a credential to another electronic device, in accordance with or more implementations. For explanatory purposes, the process 800 is primarily described herein with reference to the electronic device 102, the electronic device 104, the payment provider server 106, and the merchant server 108 of FIG. 1. However, the process 800 is not limited to the electronic device 102, the electronic device 104, the payment provider server 106, or the merchant server 108, and one or more blocks of the process 800 may be performed by one or more other components of the merchant server 108, and/or by other suitable devices. Further, for explanatory purposes, the blocks of the process 800 are described herein as occurring sequentially or linearly. However, multiple blocks of the process 800 may occur in parallel. In addition, the blocks of the process 800 need not be performed in the order shown and/or one or more blocks of the process 800 need not be performed and/or can be replaced by other operations.

At block 802, a digital wallet application may be launched on the electronic device 102. The digital wallet application may establish a communication channel with the payment provider server 106. The payment provider server 106 may be associated with a payment provider used in a transaction between a merchant server 108. The transaction may be initiated by the electronic device 104 by the user visiting a webpage associated with the merchant server 108. When the user visits the webpage with the electronic device 104, the electronic device 104, and/or an application/platform running thereon, may determine that the electronic device 104 does not support the payment provider associated with the payment provider server 106.

To establish the communication channel, the electronic device 104 may display, and the electronic device 102 may scan, a machine-readable code (e.g., QR code) representing information for establishing the communication channel with the payment provider server 106. The machine-readable code may be displayed at a user interface of the merchant website and may be scanned by an image sensor of the electronic device 102.

Additionally or alternatively, the electronic device 104 may cause a push notification to be sent to the electronic device 102 to provide the electronic device 102 with the information for establishing the communication channel. The electronic device 104 may send a request to the payment provider server 106 to send a push notification to the electronic device 102.

In some embodiments, the communication channel with the payment provider server 106 is encrypted.

At block 804, the digital wallet may receive transaction information from the payment provider server 106. The digital wallet may display at least some of the received transaction information on its user interface (e.g., user interface 500).

With the transaction information shown in the user interface, the user of the electronic device 102 may decide to make one or more modifications to the transaction. The user may make the modification on the user interface of the digital wallet. The electronic device 102 may communicate the modification to the payment provider server 106 to communicate to the electronic device 104. The electronic device 104 may coordinate with the merchant server 108 as needed to modify the state of the transaction according to the modifications. In turn, the modified transaction information may be communicated back from the electronic device 104 to the payment provider server 106, and from the payment provider server 106 to the electronic device 102. The user interface of the digital wallet on the electronic device 102 may be updated with at least some of the modified transaction information.

At block 806, the digital wallet may provide a payment credential to the payment provider server 106 once the transaction is authorized. The transaction may be authorized based on a user input to the electronic device 102 authorizing the transaction. Once authorized, the electronic device 102 may direct its secure element to encrypt and/or provide the payment credential selected by the user to the payment provider server 106, and the payment provider server 106 may relay the payment credential to the electronic device 104 for completing the transaction with the merchant server 108.

At block 808, the digital wallet may receive a result of the transaction from the payment provider server 106. After the electronic device 104 completes the transaction with the merchant server 108, electronic device 104 may report the status of the transaction to the payment provider server 106, which may relay to the electronic device 102 the status of the transaction performed on behalf of the electronic device 102. The digital wallet may display a representation of the status on its user interface to communicate the status of the transaction to the user.

FIG. 9 depicts an example electronic system 900 with which aspects of the present disclosure may be implemented, in accordance with one or more implementations. The electronic system 900 can be, and/or can be a part of, any electronic device for generating the features and processes described in reference to FIGS. 1-8, including but not limited to an electronic device 104 computer, tablet computer, smartphone, and wearable device (e.g., smartwatch, fitness band). The electronic system 900 may include various types of computer-readable media and interfaces for various other types of computer-readable media. The electronic system 900 includes one or more processing unit(s) 914, a persistent storage device 902, a system memory 904 (and/or buffer), an input device interface 906, an output device interface 908, a bus 910, a ROM 912, one or more processing unit(s) 914, one or more network interface(s) 916, a secure element 918, and/or subsets and variations thereof.

The bus 910 collectively represents all system, peripheral, and chipset buses that communicatively connect the numerous internal devices of the electronic system 900. In one or more implementations, the bus 910 communicatively connects the one or more processing unit(s) 914 with the ROM 912, the system memory 904, and the persistent storage device 902. From these various memory units, the one or more processing unit(s) 914 retrieves instructions to execute and data to process in order to execute the processes of the subject disclosure. The one or more processing unit(s) 914 can be a single processor or a multi-core processor in different implementations.

The ROM 912 stores static data and instructions that are needed by the one or more processing unit(s) 914 and other modules of the electronic system 900. The persistent storage device 902, on the other hand, may be a read-and-write memory device. The persistent storage device 902 may be a non-volatile memory unit that stores instructions and data even when the electronic system 900 is off. In one or more implementations, a mass-storage device (such as a magnetic or optical disk and its corresponding disk drive) may be used as the persistent storage device 902.

In one or more implementations, a removable storage device (such as a floppy disk, flash drive, and its corresponding disk drive) may be used as the persistent storage device 902. Like the persistent storage device 902, the system memory 904 may be a read-and-write memory device. However, unlike the persistent storage device 902, the system memory 904 may be a volatile read-and-write memory, such as RAM. The system memory 904 may store any of the instructions and data that one or more processing unit(s) 914 may need at runtime. In one or more implementations, the processes of the subject disclosure are stored in the system memory 904, the persistent storage device 902, and/or the ROM 912. From these various memory units, the one or more processing unit(s) 914 retrieves instructions to execute and data to process in order to execute the processes of one or more implementations.

The bus 910 also connects to the input device interfaces 906 and output device interfaces 908. The input device interface 906 enables a user to communicate information and select commands to the electronic system 900. Input devices that may be used with the input device interface 906 may include, for example, alphanumeric keyboards, touch screens, and pointing devices. The output device interface 908 may enable the electronic system 900 to communicate information to users. For example, the output device interface 908 may provide the display of images generated by electronic system 900. Output devices that may be used with the output device interface 908 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 910 also connects to secure element 918. The secure element 918 may include hardware and/or software that provides secure storage and management of sensitive information. The secure element 918 may be isolated from the processing unit 914 and operating system, making it more difficult for unauthorized access. The secure element 918 may be used for secure transactions and identification, such as in payment cards and digital passes. The secure element 918 may store sensitive information, such as cryptographic keys, and may protect the sensitive information (e.g., with cryptographic algorithms and access controls).

Finally, as shown in FIG. 9, the bus 910 also couples the electronic system 900 to one or more networks and/or to one or more network nodes through the one or more network interface(s) 916. In this manner, the electronic system 900 can be a part of a network of computers (such as a local area network, a wide area network, an Intranet, or a network of networks, such as the internet). Any or all components of the electronic system 900 can be used in conjunction with the subject disclosure.

Implementations within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

As described above, one aspect of the present technology is the gathering and use of data available from specific and legitimate sources for file sharing. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, personal information data can be used for file sharing. Accordingly, the use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of file sharing, the present technology can be configured to allow users to select to “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
establishing, by a digital wallet launched on a first user device, a communication channel with a first server associated with a payment provider, the payment provider being used in a transaction between a merchant website accessed on a second user device and a second server associated with the merchant website, wherein the second user device does not support the payment provider;
receiving, by the digital wallet and from the first server, transaction information corresponding to the transaction;
providing, by the digital wallet and to the first server, a payment credential stored on the first user device; and
receiving, by the digital wallet and from the first server, a result of the transaction performed using the payment credential on behalf of the first user device.

2. The method of claim 1, wherein establishing the communication channel with the first server is responsive to scanning, by a camera of the first user device, a machine-readable code presented at a user interface of the merchant website, the machine-readable code representing information for establishing the communication channel with the first server.

3. The method of claim 1, wherein establishing the communication channel with the first server is responsive to interacting with a push notification, the push notification including information for establishing the communication channel with the first server.

4. The method of claim 1, further comprising providing a user interface on the digital wallet, the user interface including at least some of the transaction information.

5. The method of claim 4, further comprising presenting a confirmation on the user interface, the confirmation being based on the result.

6. The method of claim 4, further comprising transmitting, to the first server, a modification of the transaction, wherein the modification was received via the user interface.

7. The method of claim 1, wherein providing the payment credential is in response to receiving a user input authorizing the transaction.

8. The method of claim 1, wherein the communication channel with the first server is encrypted.

9. The method of claim 1, wherein the payment credential is encrypted.

10. A first user device comprising:
a memory; and
a processor configured to:
establish, by a digital wallet launched on the first user device, a communication channel with a first server associated with a payment provider, the payment provider being used in a transaction between a merchant website accessed on a second user device and a second server associated with the merchant website, wherein the second user device does not support the payment provider;
receive, by the digital wallet and from the first server, transaction information corresponding to the transaction;
provide, by the digital wallet and to the first server, a payment credential stored on the first user device; and
receive, by the digital wallet and from the first server, a result of the transaction performed using the payment credential on behalf of the first user device.

11. The first user device of claim 10, wherein establishing the communication channel with the first server is responsive to scanning, by a camera of the first user device, a machine-readable code presented at a user interface of the merchant website, the machine-readable code representing information for establishing the communication channel with the first server.

12. The first user device of claim 10, wherein establishing the communication channel with the first server is responsive to interacting with a push notification, the push notification including information for establishing the communication channel with the first server.

13. The first user device of claim 10, wherein the processor is further configured to provide a user interface on the digital wallet, the user interface including at least some of the transaction information.

14. The first user device of claim 13, wherein the processor is further configured to present a confirmation on the user interface, the confirmation being based on the result.

15. The first user device of claim 13, wherein the processor is further configured to transmit, to the first server, a modification of the transaction, wherein the modification was received via the user interface.

16. The first user device of claim 10, wherein providing the payment credential is in response to receiving a user input authorizing the transaction.

17. The first user device of claim 10, wherein the communication channel with the first server is encrypted.

18. A non-transitory machine readable medium comprising instructions that, when executed by one or more processors on a first user device, cause the one or more processors to perform operations comprising:
establishing, by a digital wallet launched on the first user device, a communication channel with a first server associated with a payment provider, the payment provider being used in a transaction between a merchant website accessed on a second user device and a second server associated with the merchant website, wherein the second user device does not support the payment provider;
receiving, by the digital wallet and from the first server, transaction information corresponding to the transaction;
providing, by the digital wallet and to the first server, a payment credential stored on the first user device; and
receiving, by the digital wallet and from the first server, a result of the transaction performed using the payment credential on behalf of the first user device.

19. The non-transitory machine readable medium of claim 18, wherein establishing the communication channel with the first server is responsive to scanning, by a camera of the first user device, a machine-readable code presented at a user interface of the merchant website, the machine-readable code representing information for establishing the communication channel with the first server.

20. The non-transitory machine readable medium of claim 18, wherein establishing the communication channel with the first server is responsive to interacting with a push notification, the push notification including information for establishing the communication channel with the first server.
